(19) United States
(12) Patent Application Publication
(10) Pub. No.: US 2016/0085915 A1
(43) Pub. Date: Mar. 24, 2016

(54) SYSTEM AND METHOD FOR THE DE-IDENTIFICATION OF HEALTHCARE DATA

(71) Applicant: IMS Health Incorporated, Danbury, CT (US)

(72) Inventor: Yao Seow, Ambler, PA (US)

(21) Appl. No.: 14/494,420

(22) Filed: Sep. 23, 2014

(51) Int. Cl. G06F 19/00

(52) U.S. Cl. CPC G06F 19/322

(57) ABSTRACT

Methods, systems, and apparatus, including computer programs encoded on computer storage media, for de-identifying healthcare data. One method includes accessing a record of healthcare data with the computer system. The record includes patient identifying information (PII) associated with one or more persons to whom the healthcare data pertains. The computer system analyzes the PII included in the record of healthcare data and uses one or more business rules to determine how many hashed tokens to create with portions of the PII contained in the record and how to create each hashed token. The computer system de-identifies the accessed record by removing data designated as PII and stores the hashed tokens in association with the de-identified record.

### BACKGROUND

An increasing amount of patient healthcare data regarding diagnosis and treatment is being electronically entered and recorded. For example, a healthcare provider may electronically submit healthcare data for the purpose of receiving payment for services rendered. The healthcare data may be transmitted amongst healthcare providers, clearinghouses and/or providers of electronic data interchange, and/or insurance companies. Such healthcare data may include standardized codes to describe diagnoses made, services performed, or products used.

However, regulations in various countries, such as the Health Insurance Portability and Accountability Act of 1996 (HIPAA) in the U.S., restrict covered entities from disclosing protected health information (“PHI”). The disclosure of PHI is regulated because it is healthcare data with personally identifiable information (“PII”). Many data sources would be considered covered entities because the data sources produce information that may contain PHI, and PHI through its associated PII can be used to positively identify the patient with whom the healthcare data is related.

### SUMMARY

The present disclosure relates to computer-implemented methods, software, and systems for facilitating transactions for de-identifying healthcare data. In one aspect, a computer-implemented method includes accessing, with a computer system, a record of healthcare data, wherein the record includes patient identifying information (PII) associated with one or more persons to whom the healthcare data pertains. The computer system analyzes the PII to identify a type and a content of the PII included in the record of healthcare data. The computer system extracts portions of PII included in the accessed record of healthcare data. The computer system encrypts the extracted portions of PII. Based on one or more business rules and the analysis of the PII, the computer system determines a number of concatenated strings to generate. At least a portion of the one or more business rules indicate a relationship between the number of concatenated strings and the type and the content of the PII included in the record of healthcare data. Based on the one or more business rules, the computer system concatenates a plurality of the encrypted portions of PII into the determined number of concatenated strings. At least a portion of the one or more business rules indicate which encrypted portions of PII to concatenate into each concatenated string and an ordering of the encrypted portions of PII within each concatenated string. The computer system creates a corresponding number of hashed tokens to the determined number of concatenated strings by applying one or more hashing functions to each of the determined number of concatenated strings. The computer system de-identifies the accessed record by removing data designated as PII. The computer system stores the corresponding number of hashed tokens in association with the de-identified record.

Other implementations of these aspects include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by a data processing apparatus, cause the apparatus to perform the actions.

These and other aspects may each optionally include one or more of the following features. The one or more business rules may be specific to one of a plurality of geographic regions, and business rules specific to at least two of the plurality of geographic regions may indicate a different relationship between the number of concatenated strings and the type and the content of the PII included in the record of healthcare data. Additionally or alternatively, the relationship between the number of concatenated strings and the type and the content of the PII included in the record of healthcare data may indicate that the number of concatenated strings is greater when certain types of PII are not included in the record than when the certain types of PII are included in the record.

The method may further include transmitting the multiple hashed tokens and the de-identified record to a collection computing system that utilizes the multiple hashed tokens to longitudinally link the de-identified record with one or more other de-identified records containing healthcare data pertaining to the one or more persons.

Creating the multiple hashed tokens may include, for each of the determined number of concatenated strings, appending a portion of an encryption key to the concatenated string, creating an intermediary token by applying a first hashing function to the particular concatenated string that includes the appended portion of the encryption key, appending another portion of the encryption key to the intermediary token, and creating a hashed token by applying a second hashing function to the intermediary token that includes the appended other portion of the encryption key. The first hashing function may be an AES-family hashing function and/or the second hashing function may be an SHA-family hashing function.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for de-identifying healthcare data.

FIG. 2 is a flow chart of an example process for de-identifying healthcare data.

FIG. 3 is a flow chart of an example process for creating multiple strings of personal identifying information.

FIG. 4 is a flow chart of an example process for linking de-identified healthcare data.

Like reference numbers and designations in the various drawings indicate like elements.

### DETAILED DESCRIPTION

This disclosure generally describes computer-implemented methods, software, and systems for de-identifying healthcare data. For illustration purposes, the various implementations described herein will be described with regard to patient healthcare data that may be created, stored, or transmitted by healthcare professionals (e.g., doctors, nurses, technicians, and/or pharmacists), medical facilities (e.g., doctor's offices, hospitals, clinics, and/or nursing homes), healthcare service providers (e.g., insurance companies), and/or retail outlets (e.g., pharmacies). However, the described de-identification system is equally applicable to the de-identification of all types of private, personal data and the entities that create, store, or transmit that data. Additionally or alternatively, the described de-identification system may be configured to facilitate data de-identification in other types of software or hardware (e.g., advertising software or hardware).

In some implementations, the described de-identification system is configured to protect and de-identify healthcare data by converting elements of PII into one or more anonymous linking tokens that facilitate tracking and analysis of the healthcare data by uniquely identifying the healthcare data while preserving the anonymity of the individual associated with the healthcare data. For example, the described de-identification system may form the anonymous linking tokens from predetermined portions of PII contained in a record of healthcare data and replacing the PII in that record of healthcare data with the anonymous linking tokens. The healthcare data is “de-identified” by removing all information considered to be PII. The anonymous linking tokens are then appended to the healthcare data. The use of multiple anonymous linking tokens based on varying combinations of PII increases the likelihood of linking the de-identified healthcare data with other de-identified healthcare data associated with the same individual patient.

The anonymous linking tokens allow for linking or associating of healthcare data for a particular person even though the healthcare data has no direct identifiers, comes from different data sources, and was created at different times. In some implementations, the de-identified data with the appended anonymous linking tokens is sent to one or more data warehouses that can join several data files at the de-identified patient-specific level. At the one or more data warehouses, the anonymous linking tokens can be replaced with or augmented by an indexing tag. By replacing the anonymous linking tokens, which is based on portions of PII, with the indexing tag, the healthcare data is further de-identified because it contains no PII, and the anonymous linking tokens, which are based on portions of PII, are replaced by the indexing tag. Data can then be linked (i.e., associated with other data related to the same person) and clustered without using PII or any data based on PII. By de-identifying the healthcare data in this manner, the de-identification system supports the detailed analysis of patient-level healthcare data while complying with regulations governing the storage and transmission of patient healthcare data.

In some implementations, the de-identification system is configured to handle de-identification in a number of different countries or other geographical regions, complying with the local regulations governing the storage and transmission of patient healthcare data. For example, the de-identification system may be configured to designate various fields with a record of healthcare data as PII for purposes of de-identification depending on the regulations for the relevant jurisdiction(s). Additionally or alternatively, the de-identification system may rely upon different portions of PII in creating the one or more anonymous linking tokens, depending on the regulations for the relevant jurisdiction(s). Additionally or alternatively, the de-identification system may employ varying encryption algorithms depending on the regulations for the relevant jurisdiction(s).

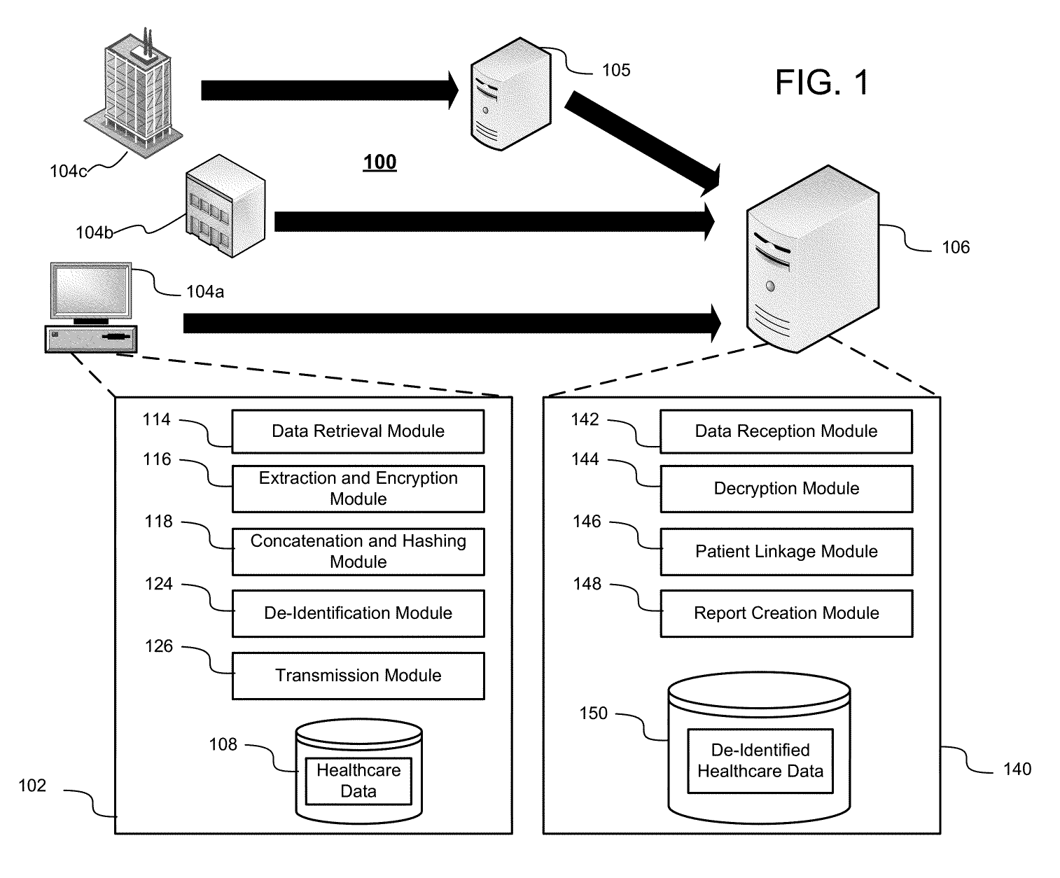

FIG. 1 is a block diagram illustrating an example system for de-identifying healthcare data. The example healthcare de-identification system 100 illustrated in FIG. 1 is shown as including a source-side component 102 and a collection-side component 140. Each of the source-side component 102 and collection-side component 140 may be implemented on one or more computers. The implementation shown in FIG. 1 illustrates multiple instances of the source-side component 102, each being implemented across one or more computers. For example, the source-side component 102 may be implemented on a computer 104a at a doctor's office, across a computer system 104b at a clinic, and/or across a computer system 104c at an insurance company. Additionally or alternatively, the source-side component 102 or a portion thereof may also be implemented on one or more computer systems 105 located at one or more trusted third-party intermediaries. The collection-side component 140 may similarly be implemented on one or more computer systems 106 at one or more sites that collect and analyze de-identified healthcare data.

Though the healthcare de-identification system 100 is illustrated as including a source-side component 102 and a collection-side component 140, the healthcare de-identification system 100 may be logically divided into more or fewer components and implemented at more or fewer locations while still performing the same or similar processing functions, as will be described in greater detail below. For example, where regional privacy laws permit and proper agreements are in place, the source-side component 102 may be implemented entirely at trusted third party intermediaries to which various sources of healthcare data (e.g., healthcare professionals, medical facilities, healthcare service providers, and/or retail outlets) send healthcare data using secure communication means (e.g., secure FTP).

The source-side component 102 will be described as including one or more storage devices 108 that store healthcare data. The stored healthcare data may be input by a user (e.g., a healthcare professional) of the computer or computer system on which the source-side component 102 is implemented. Additionally or alternatively, the stored healthcare data may be received from another computer or computer system. For example, the computer system 104b located at a clinic may include multiple computers at which users enter healthcare data. The source-side component 102 may be implemented on one or more of these multiple computers. For example, in some implementations, each computer at which healthcare data is entered may implement an instance of source-side component 102. Additionally or alternatively, the source-side component 102 may be implemented at one of the multiple computers located at the clinic and the other computers may send input healthcare data to the computer implementing the source-side component 102.

The healthcare data stored in the one or more storage devices 108 is data that pertains to the health, condition, disease, treatment, and other similar information of a particular person. The healthcare data may include personal identifying information (PII) for identifying the person to whom the healthcare data pertains. The healthcare data can include, but is not limited to, diagnoses, patient visit information, drug data, procedure data, prescription specific information, laboratory data, data feeds, test orders, test results, consultant's report, and other similar data related to or associated with the health of a person. In some implementations, the healthcare data may include standardized codes to describe the diagnoses made, services performed, products used, and other relevant information.

For ease of explanation, the following disclosure may refer to healthcare data with regard to a record. However, the term record is not meant to limit the content, format, quantity, or quality of healthcare data or the manner in which it is provided, stored, or processed. Rather, a record is simply being used to refer to a discrete quantity of healthcare data that contains PII identifying one or more persons to whom the healthcare data corresponds. In some implementations, the healthcare data may be provided on a standard form, such as CMS-1500/837p, CMS-1450/uB-92/uB-04/837i, NCPDP 5.1, or other similar forms. However, the healthcare data may be provided or stored in one or more data structures that take any standard or non-standard format. In some implementations, for example, the healthcare data may be contained in healthcare insurance claims from pharmacies and physicians. Moreover, the term record does not limit the source of the healthcare data. In some implementations, for example, the healthcare data may be provided directly by a healthcare provider or provided by a central clearinghouse, a payer, a pharmacy benefits manager, or other similar sources of health care data.

The PII contained in the healthcare data may come in various forms. For example, PII may include, but is not limited to, direct identifiers, such as names, elements of addresses, birth dates, social security numbers, insurance policy numbers, and/or license numbers. Additionally or alternatively, PII may include indirect identifiers that may not, on their own, identify a person, but that may, in combination with other information, be used to identify a person. Whether or not one or more portions of healthcare data contained in a record are considered to be PII may be dictated by legal rules and regulations, privacy policies, and/or the individuals and organizations that create, provide, store, or process healthcare data.

In some implementations, the healthcare de-identification system 100 is provided with business rules that identify which portions of healthcare data contained in a record are considered to be PII and how to handle that PII. These PII business rules may be static or dynamic and may take any form. The term business rule is not meant to be limiting, and simply refers to any data, logic, or instruction that informs the handling of PII. The PII business rules may, for example, be provided to the healthcare de-identification system 100 by an individual or entity that designs, builds, implements, operates, and/or maintains the healthcare de-identification system 100. For example, the PII business rules may be hardcoded into the healthcare de-identification system 100 by an individual or entity that designs the healthcare de-identification system 100. Additionally or alternatively, the healthcare de-identification system 100 may be configured to obtain PII business rules from one or more sources. For example, the healthcare de-identification system 100 may be configured to obtain PII business rules or information relevant to PII business rules from government organizations that disseminate information regarding rules, regulations, and/or statutes governing healthcare data.

In some implementations, the record itself may contain data that identifies which portions correspond to PII. Additionally or alternatively, a user or administrator of the healthcare de-identification system 100 may identify which portions of a record correspond to PII. For example, a healthcare professional may identify portions of healthcare data as being PII as the healthcare professional enters healthcare data into the healthcare de-identification system 100. In another example, a healthcare professional or other user may designate portions of healthcare data as PII while reviewing previously stored healthcare data.

For illustrative purposes, the source-side component 102 will be described as including a data retrieval module 114, an extraction and encryption module 116, a concatenation and hashing module 118, a de-identification module 124, and a transmission module 126. However, the source-side component 102 may be any computing platform capable of performing the described functions. For example, the source-side component 102 may include one or more computing systems that may include hardware, software, or a combination of both for performing the described functions. Moreover, the data retrieval module 114, extraction and encryption module 116, concatenation and hashing module 118, de-identification module 124, and transmission module 126 may be embodied together or separately in hardware and/or software. Though the data retrieval module 114, extraction and encryption module 116, concatenation and hashing module 118, de-identification module 124, and transmission module 126 will be described as each carrying out certain functionality, the described functionality may be performed by one or more other modules in conjunction with or in place of the described module. In some implementations, the data retrieval module 114, extraction and encryption module 116, concatenation and hashing module 118, de-identification module 124, and transmission module 126 may each be implemented across more than one computer or computer system. For example, in the computer system 104b located at a clinic, each computer included in the computer system 104b may implement one or more of the data retrieval module 114, extraction and encryption module 116, concatenation and hashing module 118, de-identification module 124, and transmission module 126 while a single central computer of the computer system 104b may implement the other modules.

For illustrative purposes, the collection-side component 140 will be described as including a data reception module 142, a decryption module 144, a patient linkage module 146, and a report creation module 148. However, the collection-side component 140 may be any computing platform capable of performing the described functions. For example, the collection-side component 140 may include one or more computing systems that may include hardware, software, or a combination of both for performing the described functions. Moreover, the data reception module 142, decryption module 144, patient linkage module 146, and report creation module 148 may be embodied together or separately in hardware and/or software. Though the data reception module 142, decryption module 144, patient linkage module 146, and report creation module 148 will be described as each carrying out certain functionality, the described functionality may be performed by one or more other modules in conjunction with or in place of the described module. In some implementations, the data reception module 142, decryption module 144, patient linkage module 146, and report creation module 148 may each be implemented across more than one computer or computer system. For example, in the computer system 106 located at a collection site, each computer included in the computer system 106 may implement one or more of the data reception module 142, decryption module 144, patient linkage module 146, and report creation module 148.

The collection-side component 140 will also be described as including one or more storage devices 150 that store de-identified healthcare data. The one or more storage devices 150 may be configured to store de-identified healthcare data received from one or more source-side components 102. Additionally or alternatively, the one or more storage devices 150 may be configured to store de-identified healthcare data that has been longitudinally linked by patient linkage module 146. Additionally or alternatively, the one or more storage devices 150 may be configured to store one or more reports created by the report creation module 148.

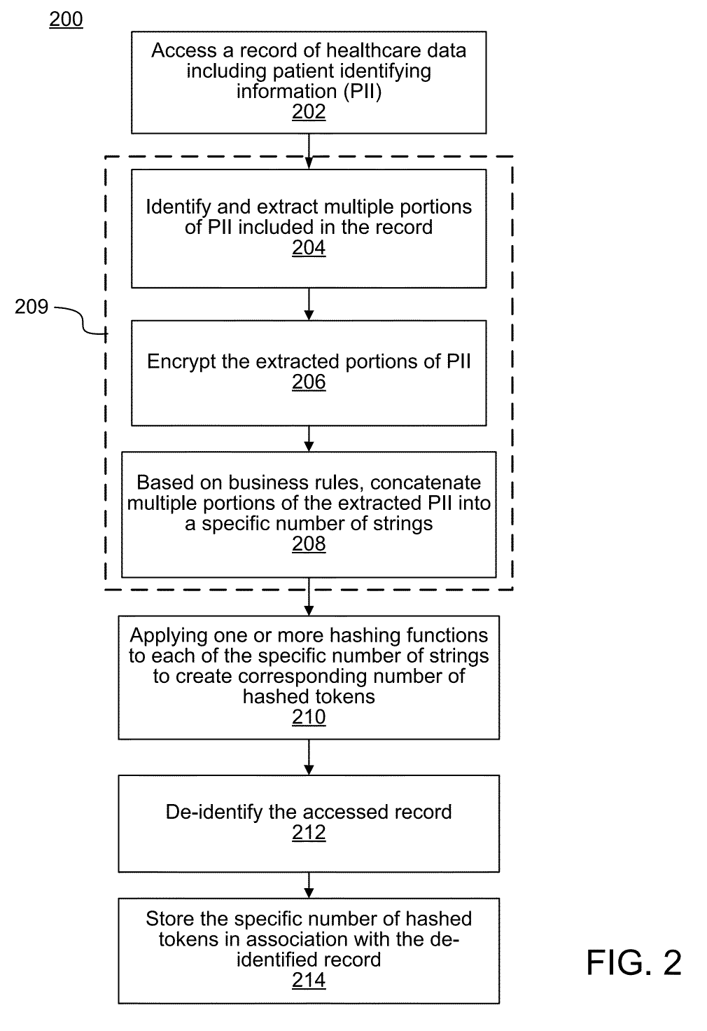

The operation of the healthcare de-identification system 100 illustrated in FIG. 1 will now be described with regard to FIGS. 2-4. However, the processes described with regard to FIGS. 2-4 may be implemented on any computing system(s). FIG. 2 is a flow chart of an example process 200 for de-identifying healthcare data.

At 202, the data retrieval module 114 accesses a record of healthcare data including patient identifying information (PII). In some implementations, the data retrieval module 114 is configured to access the record of healthcare data from the one or more storage devices 108. Additionally or alternatively, the data retrieval module 114 may be configured to access the record of healthcare data from one or more offsite storage devices and/or to receive the record of healthcare data directly from a user interfacing with the healthcare de-identification system 100 through a user interface.

At 204, the extraction and encryption module 116 is configured to identify and extract multiple portions of PII included in the record. In some implementations, as part of operation 204, the extraction and encryption module 116 is configured to identify a format of the record and utilize business rules specific to the identified format to parse the record and identify the PII. In some implementations, the record of healthcare data may be divided into various fields. Certain fields contained in the record may be of easily identifiable type and format. For example, the record of healthcare data may include first and last name fields, a gender field, a date of birth field, an address field, a physician's name field, and one or more diagnosis fields. These easily identified types of fields may conform to a specific format or rely upon a set of selectable values. Other fields contained in the record may be more difficult to easily classify without knowledge of the record's format. For example, the record of healthcare data may contain one or more text fields that permit a user to enter text in any format. These text fields may include, for example, treatment fields and/or notes fields.

Specific sources of healthcare data records may format records to include a specific set of data fields. In some implementations, these specific sources of records may provide information about the format they utilize for their healthcare data records. Additionally or alternatively, in some implementations, a user or administrator of the healthcare de-identification system 100 may review healthcare data records received from these specific sources to analyze and classify the general format of these records. Regardless of the source of formatting information, the healthcare de-identification system 100 may be configured to utilize record formatting information along with information about laws, regulations, and rules regarding the protection of PII to designate various portions of a healthcare data record as PII.

In some implementations, the extraction and encryption module 116 may be configured to standardize and format part or all of the healthcare information contained in the accessed record. For example, the extraction and encryption module 116 may be configured to convert part or all of the data contained in the accessed record to UTF-8 format. In another example, the extraction and encryption module 116 may be configured to standardize fields within the healthcare data (e.g., converting text to upper-case).

Moreover, as part of identifying and extracting PII, the extraction and encryption module 116 may be configured to convert certain values to formats that conform with certain rules and regulations governing the handling of PII. For example, in some implementations, the extraction and encryption module 116 may be configured to convert a date of birth contained in the accessed record to an age group so as to obfuscate the actual birth date.

Additionally, as part of identifying PII, the extraction and encryption module 116 may be configured to identify the type and content of the PII included in the data record. In some implementations, for example, the extraction and encryption module 116 may utilize information regarding the overall format of the healthcare data record to determine where in the record certain PII should be located. With information concerning the potential location of PII, the extraction and encryption module 116 may be configured to determine the type of PII actually present in the record and whether the content of the PII is valid. For example, a healthcare data record may include fields for first and last name. The extraction and encryption module 116 may be configured to utilize information regarding the presence and location of the first and last name fields to determine whether the field includes any data (i.e., whether the field is blank) and whether data contained in the field may be a valid first and last name. For example, valid data contained in first and last name fields usually does not contain numbers or certain special characters. Therefore, extraction and encryption module 116 may be configured to analyze the data contained in the first and last name fields to determine whether the data contains any of these impermissible characters, and, if so, designate the data as invalid. In some implementations, the healthcare de-identification system 100 only utilizes valid PII for creating the hashed tokens that will be described in greater detail below.

In some implementations, when the extraction and encryption module 116 extracts PII from the healthcare data record, the extraction and encryption module 116 simply creates a copy of the extracted PII, while leaving the PII in the healthcare data record. Alternatively, when the extraction and encryption module 116 extracts PII from the healthcare data record, the extraction and encryption module 116 removes the extracted PII from the healthcare data record. In some implementations, the extraction and encryption module 116 utilizes business rules to determine which portions of PII to extract from the healthcare data record. The business rules may be specific to a geographic region, a type or other classification of the healthcare data record, or the source of the healthcare data record. For example, the business rules may indicate that the laws, rules, or regulations associated with a first geographic region allow certain data that would be considered PII in a second, different geographic region to remain included in a healthcare data record. The identification of the type and content of the PII included in the data record may happen before, during, or after the extraction of the PII from the healthcare data record.

At 206, the extraction and encryption module 116 is configured to encrypt certain portions of the PII. In some implementations, the extraction and encryption module 116 is configured to encrypt each portion of extracted PII individually. In some implementations, the extraction and encryption module 116 may be configured to encrypt a combination of extracted portions of PII. For example, the extraction and encryption module 116 may encrypt a first letter contained in a first name field of a healthcare data record and the entire last name contained in a last name field. In another example, the extraction and encryption module 116 may wait to encrypt the extracted portions of PII until after the creation of one or more strings of PII that will be described with regard to operation 208. The extraction and encryption module 116 may utilize any suitable encryption algorithm or method to encrypt the extract portions of PII. For example, the extraction and encryption module 116 may utilize key-based encryption (e.g., RSA, DSA, or AES), hash function, or any other suitable encryption method. In some implementations, for example, the extraction and encryption module 116 may encrypt one or more of the extracted portions of PII using AES-128.

At 208, the concatenation and hashing module 118 concatenates multiple portions of the extracted PII into a specific number of strings. Ultimately, the concatenation and hashing module 118 creates one or more hashed tokens that may be used by one or more collection-side components 140 to link de-identified healthcare data records. However, the number of hashed tokens may be varied based on a number of different factors. Thus, in some implementations, the concatenation and hashing module 118 is configured to utilize the analysis of the PII contained in the healthcare data record performed by the extraction and encryption module 116 in conjunction with one or more business rules to determine how many concatenated strings of extracted PII (and ultimately hashed tokens) to create.

In some implementations, the one or more business rules utilized by the concatenation and hashing module 118 may be specific to a geographic region. Thus, depending on a geographic region associated with the healthcare data record and/or the healthcare de-identification system 100, the one or more business rules may indicate that a certain number of strings of extracted PII should be created. Additionally or alternatively, the one or more business rules may indicate that the laws, rules, or regulations associated with a geographic region require that healthcare data records always include certain PII. As a result, the one or more business rules may indicate that the number of strings of extracted PII can be fewer, since all healthcare data records within the region will uniformly include a certain amount of PII, making it more likely that the created hashed tokens can be used to accurately link de-identified records.

In some implementations, the one or more business rules by the concatenation and hashing module 118 may define a relationship between the amount, type, and content of PII included in a healthcare data record and the number of strings of extracted PII to be created. For example, certain PII (e.g., social security number or healthcare insurance number) is very accurate in identifying a person, while other PII (e.g., zip code or age group) are unlikely to uniquely identify an individual, though they may be useful in narrowing a potential group of matching persons. The greater the amount of PII that is included in a healthcare data record, the more likely that two healthcare data records with the same PII are matches. Unfortunately, given the great number of possible sources of healthcare data records and the great number of potential formats a healthcare data record might take, the amount of PII included in any one healthcare record may vary. Moreover, where a healthcare data record only includes (or regional laws, rules, or regulations only permit consideration of) PII that can narrow a group of potential persons but not uniquely identify them, it can be helpful to consider as much PII as possible to increase the statistical likelihood of matching two de-identified healthcare data records. Accordingly, the amount, type, and content of PII included in a healthcare data record may increase or decrease a number of strings to be generated in order to satisfy a statistical likelihood of matching de-identified patient records.

The concatenation and hashing module 118 also utilizes one or more business rules to determine which extracted PII to include in each concatenated string and in which order. As with the number of concatenated strings to be created, the business rules indicating the content and ordering of the strings of extracted PII are generally designed to increase the statistical likelihood that the resulting hashed tokens can be matched with hashed tokens associated with other healthcare data records related to the same person(s). In one example, the concatenation and hashing module 118 may utilize the one or more business rules and the analysis of the PII performed by the extraction and encryption module 116 to determine that two strings should be created for a particular healthcare data record. The one or more business rules may indicate that a first string should include encrypted versions of the person's last name, date of birth, and zip code, and that a second string should include encrypted versions of the person's first name, last name, and insurance provider. Of course, the number of strings to be created and the ordering and content of the strings can be varied in any way.

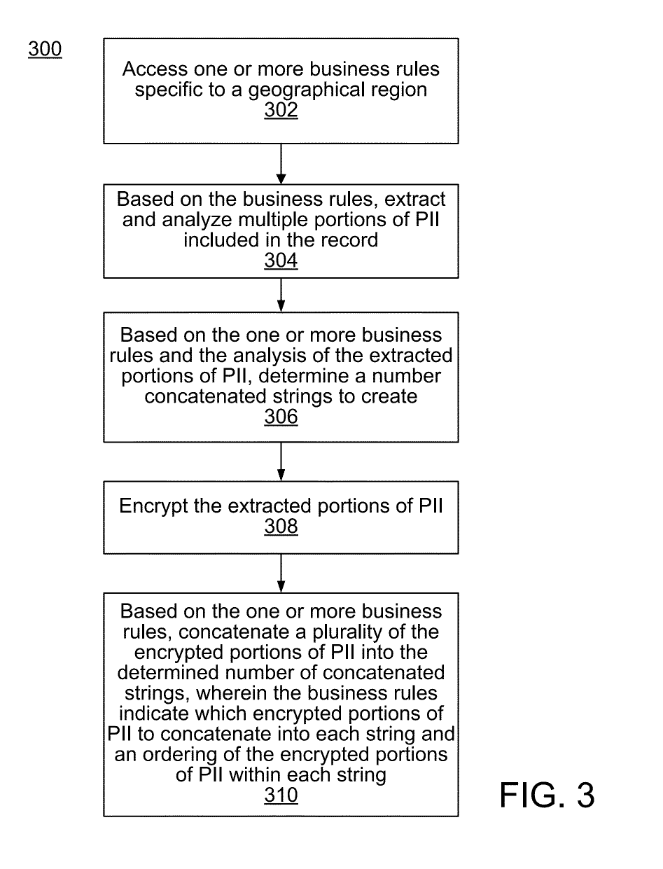

The source-side component 102 may perform operations 204, 206, and 208 (identified collectively as token creation sub-process 209) in many different ways. For example, the details of the one or more business rules relied upon in each operation may vary depending on a number of factors (e.g., geographic region, type of healthcare data record, details regarding the person(s) to whom the healthcare data record relates, etc.). One example of token creation sub-process 209 is described with regard to FIG. 3. However, other variations of token creation sub-process 209 may be utilized.

At 210, the concatenation and hashing module 118 is configured to apply one or more hashing functions to each of the specific number of strings to create a corresponding number of hashed tokens. The number and type of hashing functions used by the concatenation and hashing module 118 to hash each of the concatenated strings of PII may vary. Moreover, another cryptographic primitive, such as a block cipher, can be used instead of a hashing function. However, the hash function may be preferred because it generally has no inverse function that can recover the input from the hash function's output. A hash function maps a bit string of arbitrary length to another bit string of fixed length. Hash functions include Ripe-MD, Whirlpool, Haval, MD4, MD5, and the SHA group of hash functions. Preferably, the concatenation and hashing module 118 utilizes the SHA-2 family, in particular, SHA-256 which creates 256 bit hashes. The SHA family of hash functions was designed by the National Institute of Standards and Technology and is a Federal Information Processing Standard, as described by Federal Information Processing Standards Publication 180-2, dated Aug. 1, 2002. Federal Information Processing Standards Publication 180-2 also provides an algorithm and examples for implementing an SHA-256 hash function.

In some implementations, the concatenation and hashing module 118 may be configured to apply multiple hashing functions to each of the concatenated strings of PII. For example, in some implementations, the concatenation and hashing module 118 may, for each of the concatenated strings of PII, append a portion of an encryption key to the concatenated string. The concatenation and hashing module 118 may then create an intermediary token by applying a first hashing function (e.g., SHA-256) to the concatenated string with the appended portion of the encryption key. The concatenation and hashing module 118 may then append another portion of the encryption key to the intermediary token. The concatenation and hashing module 118 may then create a final hashed token by applying a second hashing function (e.g., SHA-256) to the intermediary token with the appended other portion of the encryption key.

At 212, the de-identification module 124 de-identifies the accessed healthcare data record. In some implementations, the de-identification module 124 creates a copy of the accessed data record and de-identifies the copy. In other implementations, the de-identification module 124 de-identifies the healthcare data record stored in the one or more storage devices 108. To de-identify a healthcare data record, the de-identification module 124 removes data designated as PII from the healthcare data record. For example, regional laws, rules, and/or regulations may indicate that fields containing certain types of data should be designated as PII and handled accordingly. Though the designation and protection of PII by the healthcare de-identification system 100 is designed to conform with all applicable laws, rules, and regulations regarding PII, certain PII may still be contained in a record, even after removal of designated PII.

At 214, the transmission module 126 is configured to store the specific number of hashed tokens created in operation 210 in association with the healthcare data records de-identified in operation 212. In some implementations, the transmission module 126 is configured to store the specific number of hashed tokens with the de-identified healthcare data record. In some implementations, the transmission module 126 is configured to store the specific number of hashed tokens separately from the de-identified healthcare data record and link them together through known linking techniques.

In some implementations, the transmission module 126 is configured to store a PII presence indicator along with either or both of the hashed tokens and the de-identified healthcare data record. The PII presence indicator indicates which types of PII are contained in each token. For example, the business rules may indicate that a particular hashed token created for a record of healthcare data should be based on the last name field, the postal code field, and the age field included in the record of healthcare data. However, the record of healthcare data may not include the last name field or it may otherwise be determined to be invalid. In such an instance, the concatenation and hashing module 118 may be configured to use a preset NULL value in place of the last name field when creating the hashed token. In such a case the PII presence indicator will indicate that the last name field will indicate that the last name field was not present in the original record. The PII presence indicator may then be used, for example, by the patient linkage module 146 when attempting to link de-identified patient records.

Moreover, in some implementations, the transmission module 126 is configured to transmit the specific number of hashed tokens separately and the de-identified healthcare data record to another location or computer system, such as the collection-side component 140. The transmission module 126 may utilize any known forms of storage (e.g., RAM, ROM, optical drive, etc.), transmission method (e.g., e-mail, SFTP, etc.), and transmission medium (wired, wireless, etc.).

FIG. 3 is a flow chart of an example process 300 for creating multiple strings of personal identifying information. Process 300 is one example of the token creation sub-process 209 described with regard to FIG. 2. At 302, the concatenation and hashing module 118 accesses one or more business rules specific to a geographical region associated with the healthcare data record or the healthcare de-identification system 100. At 304, the concatenation and hashing module 118 utilizes the one or more accessed business rules to extract and analyze multiple portions of PII included in the record. As described above with regard to FIG. 2, the process of extraction and analysis may include identifying an amount, type, and content of PII included in a healthcare data record.

At 306, based on the one or more business rules and the analysis of the extracted portions of PII, the concatenation and hashing module 118 determines a number concatenated strings to create. The number of strings of concatenated PII may vary depending on the type and the content of the PII included in the record of healthcare data. For example, the relationship between the number of concatenated strings and the type and the content of the PII included in the record of healthcare data indicates that the number of concatenated strings is greater when certain types of PII are not included in the record than when the certain types of PII are included in the record.

At 308, the extraction and encryption module 116 individually encrypts each of the extracted portions of PII. As described with regard to FIG. 2, the extraction and encryption module 116 may utilize any suitable encryption algorithm or method to encrypt the extract portions of PII. At 310, the concatenation and hashing module 118 utilizes one or more business rules to concatenate a plurality of the encrypted portions of PII into the determined number of concatenated strings. In some implementations, the one or more business rules indicate which encrypted portions of PII to concatenate into each string and an ordering of the encrypted portions of PII within each string. As described above with regard to FIG. 2, these business rules may be specific to a geographic region.

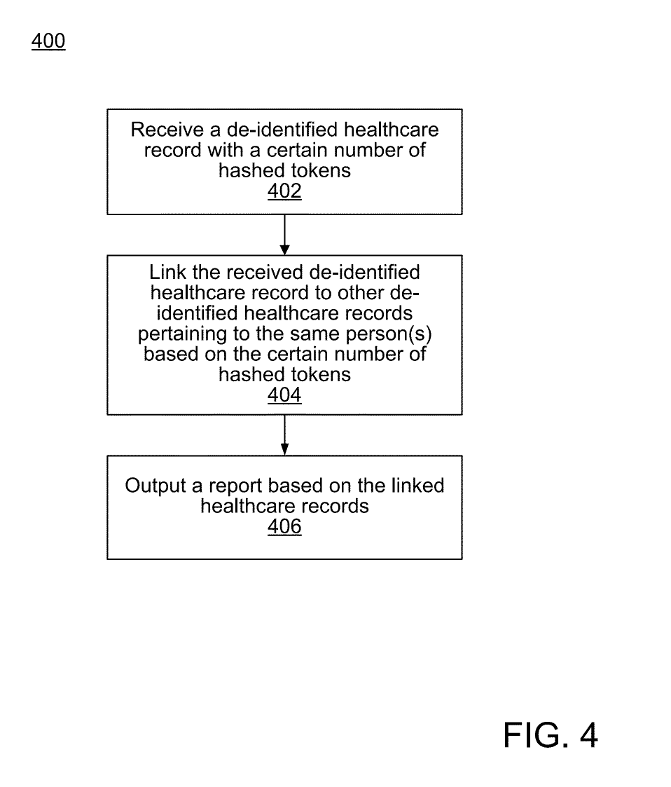

FIG. 4 is a flow chart of an example process 400 for linking de-identified healthcare data. For purposes of illustration, the process 400 will be described with regard to collection-side component 140. However, any computing system(s) can be utilized to perform the described functions.

At 402, the data reception module 142 receives a de-identified healthcare record in association with a certain number of hashed tokens. In some implementations, the de-identified healthcare record is encrypted before it is transmitted to the collection-side component 140. In such implementations, the decryption module 144 decrypts the encrypted de-identified healthcare record and the certain number of hashed tokens.

At 404, the patient linkage module 146 compares the certain number of hashed tokens received with the de-identified healthcare record with other hashed tokens associated with previously received and stored de-identified healthcare records. The patient linkage module 146 attempts to find the most likely match between the hashed tokens received with the de-identified healthcare record and the previously received hashed tokens in order to link de-identified healthcare records that correspond to the same person(s). In some implementations, de-identified healthcare records that correspond to the same person(s) are stored in association with an anonymous profile corresponding to the person(s).

At 406, the report creation module 148 creates and outputs one or more reports based on the linked healthcare records. In some implementations, the report may provide statistical analysis of stored, de-identified healthcare data, demographic analysis of stored, de-identified healthcare data, and other similar outputs. The contents of the report can be customized to the requirements of the user. For example, the report can include how often a certain medical procedure was completed in a certain city, the demographic data associated with prescriptions of a certain class of drugs, and other similar data. The report can be, but is not limited to, a paper report, electronic data, a data feed, a program, or any other suitable output. The report creation module 148 can create a report with a predetermined form and format.

The report provided by report creation module 148 may be available in near real-time because the report can be provided shortly after the healthcare data is entered into or otherwise received by the system 100. By providing near real-time reports, the system 100 can provide detection and tracking of specific diseases and syndromes by analyzing records for that specific malady. The report can also be used for detection and geo-spatial tracking of a new infectious disease by searching the stored healthcare data for the occurrence of the new infectious disease and how frequently the new disease occurs in different geographical areas and then reporting the results of the search. The system 100 can also track other events, such as bioterrorism events that impact the healthcare system in a way similar to infectious diseases.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A method comprising:
accessing, with a computer system, a record of healthcare data, wherein the record includes patient identifying information (PII) associated with one or more persons to whom the healthcare data pertains;
analyzing, with the computer system, the PII to identify a type and a content of the PII included in the record of healthcare data;
extracting, with the computer system, portions of PII included in the accessed record of healthcare data;
encrypting, with the computer system, the extracted portions of PII;
based on one or more business rules and the analysis of the PII, determining, with the computer system, a number of concatenated strings to generate, wherein at least a portion of the one or more business rules indicate a relationship between the number of concatenated strings and the type and the content of the PII included in the record of healthcare data;
based on the one or more business rules, concatenating, with the computer system, a plurality of the encrypted portions of PII into the determined number of concatenated strings, wherein at least a portion of the one or more business rules indicate which encrypted portions of PII to concatenate into each concatenated string and an ordering of the encrypted portions of PII within each concatenated string;
creating, with the computer system, a corresponding number of hashed tokens to the determined number of concatenated strings by applying one or more hashing functions to each of the determined number of concatenated strings;
de-identifying, with the computer system, the accessed record by removing data designated as PII; and
storing, with the computer system, the corresponding number of hashed tokens in association with the de-identified record.

2. The method of claim 1, wherein the one or more business rules are specific to one of a plurality of geographic regions, and business rules specific to at least two of the plurality of geographic regions indicate a different relationship between the number of concatenated strings and the type and the content of the PII included in the record of healthcare data.

3. The method of claim 1, wherein the relationship between the number of concatenated strings and the type and the content of the PII included in the record of healthcare data indicates that the number of concatenated strings is greater when certain types of PII are not included in the record than when the certain types of PII are included in the record.

4. The method of claim 1, further comprising transmitting the multiple hashed tokens and the de-identified record to a collection computing system that utilizes the multiple hashed tokens to longitudinally link the de-identified record with one or more other de-identified records containing healthcare data pertaining to the one or more persons.

5. The method of claim 1, wherein creating the multiple hashed tokens comprises, for each of the determined number of concatenated strings:
appending a portion of an encryption key to the concatenated string;
creating an intermediary token by applying a first hashing function to the particular concatenated string that includes the appended portion of the encryption key;
appending another portion of the encryption key to the intermediary token; and
creating a hashed token by applying a second hashing function to the intermediary token that includes the appended other portion of the encryption key.

6. The method of claim 5, wherein the first hashing function is an AES-family hashing function and the second hashing function is an SHA-family hashing function.

7. A non-transitory computer storage medium encoded with a computer program, the program comprising instructions that when executed by one or more computers cause the one or more computers to perform operations comprising:
accessing, with a computer system, a record of healthcare data, wherein the record includes patient identifying information (PII) associated with one or more persons to whom the healthcare data pertains;
analyzing, with the computer system, the PII to identify a type and a content of the PII included in the record of healthcare data;
extracting, with the computer system, portions of PII included in the accessed record of healthcare data;
encrypting, with the computer system, the extracted portions of PII;
based on one or more business rules and the analysis of the PII, determining, with the computer system, a number of concatenated strings to generate, wherein at least a portion of the one or more business rules indicate a relationship between the number of concatenated strings and the type and the content of the PII included in the record of healthcare data;
based on the one or more business rules, concatenating, with the computer system, a plurality of the encrypted portions of PII into the determined number of concatenated strings, wherein at least a portion of the one or more business rules indicate which encrypted portions of PII to concatenate into each concatenated string and an ordering of the encrypted portions of PII within each concatenated string;
creating, with the computer system, a corresponding number of hashed tokens to the determined number of concatenated strings by applying one or more hashing functions to each of the determined number of concatenated strings;
de-identifying, with the computer system, the accessed record by removing data designated as PII; and
storing, with the computer system, the corresponding number of hashed tokens in association with the de-identified record.

8. The non-transitory computer storage medium of claim 7, wherein the one or more business rules are specific to one of a plurality of geographic regions, and business rules specific to at least two of the plurality of geographic regions indicate a different relationship between the number of concatenated strings and the type and the content of the PII included in the record of healthcare data.

9. The non-transitory computer storage medium of claim 7, wherein the relationship between the number of concatenated strings and the type and the content of the PII included in the record of healthcare data indicates that the number of concatenated strings is greater when certain types of PII are not included in the record than when the certain types of PII are included in the record.

10. The non-transitory computer storage medium of claim 7, the program further comprising instructions that when executed by the one or more computers cause the one or more computers to transmit the multiple hashed tokens and the de-identified record to a collection computing system that utilizes the multiple hashed tokens to longitudinally link the de-identified record with one or more other de-identified records containing healthcare data pertaining to the one or more persons.

11. The non-transitory computer storage medium of claim 7, wherein creating the multiple hashed tokens comprises, for each of the determined number of concatenated strings:
appending a portion of an encryption key to the concatenated string;
creating an intermediary token by applying a first hashing function to the particular concatenated string that includes the appended portion of the encryption key;
appending another portion of the encryption key to the intermediary token; and
creating a hashed token by applying a second hashing function to the intermediary token that includes the appended other portion of the encryption key.

12. The non-transitory computer storage medium of claim 11, wherein the first hashing function is an AES-family hashing function and the second hashing function is an SHA-family hashing function.

13. A system comprising:
a source-side computer system comprising one or more processors and one or more storage devices containing healthcare data, wherein the source-side computer system is configured to:
access a record of healthcare data, wherein the record includes patient identifying information (PII) associated with one or more persons to whom the healthcare data pertains,
analyze the PII to identify a type and a content of the PII included in the record of healthcare data,
extract portions of PII included in the accessed record of healthcare data,
encrypt the extracted portions of PII,
based on one or more business rules and the analysis of the PII, determine a number of concatenated strings to generate, wherein at least a portion of the one or more business rules indicate a relationship between the number of concatenated strings and the type and the content of the PII included in the record of healthcare data,
based on the one or more business rules, concatenate a plurality of the encrypted portions of PII into the determined number of concatenated strings, wherein at least a portion of the one or more business rules indicate which encrypted portions of PII to concatenate into each concatenated string and an ordering of the encrypted portions of PII within each concatenated string,
create a corresponding number of hashed tokens to the determined number of concatenated strings by applying one or more hashing functions to each of the determined number of concatenated strings,
de-identify the accessed record by removing data designated as PII, and
transmit the corresponding number of hashed tokens in association with the de-identified record; and
a collection-side computer system comprising one or more processors and one or more storage devices containing de-identified healthcare data, wherein the collection-side computer system is configured to:
receive, from the source-side computer system, the transmitted corresponding number of hashed tokens in association with the de-identified record,
longitudinally link the received de-identified record with other de-identified healthcare data associated with the same one or more persons based on the received hashed tokens.

14. The system of claim 13, wherein the one or more business rules are specific to one of a plurality of geographic regions, and business rules specific to at least two of the plurality of geographic regions indicate a different relationship between the number of concatenated strings and the type and the content of the PII included in the record of healthcare data.

15. The system of claim 13, wherein the relationship between the number of concatenated strings and the type and the content of the PII included in the record of healthcare data indicates that the number of concatenated strings is greater when certain types of PII are not included in the record than when the certain types of PII are included in the record.

16. The system of claim 13, wherein the source-side computer system is configured to create a PII presence indicator for each of the corresponding number of hashed tokens, each PII presence indicator including information about whether the accessed record includes a valid value for each of the portions of PII included in each concatenated string corresponding to each of the corresponding number of hashed tokens.

17. The system of claim 13, wherein source-side computer system is configured to create the multiple hashed tokens by, for each of the determined number of concatenated strings:
appending a portion of an encryption key to the concatenated string;
creating an intermediary token by applying a first hashing function to the particular concatenated string that includes the appended portion of the encryption key;
appending another portion of the encryption key to the intermediary token; and
creating a hashed token by applying a second hashing function to the intermediary token that includes the appended other portion of the encryption key.

18. The method of claim 17, wherein the first hashing function is an AES-family hashing function and the second hashing function is an SHA-family hashing function.
